(19) United States
(12) Patent Application Publication
(10) Pub. No.: US 2004/0145175 A1
(43) Pub. Date: Jul. 29, 2004

(54) File device having white board member

(76) Inventor: Jui Yang Chang, Taichung (TW)

Correspondence Address: Jui Yang Chang, P.O. Box 63-298, Taichung, 406, TW

(21) Appl. No.: 10/355,902

(22) Filed: Jan. 27, 2003

(51) Int. Cl. B42D 3/00

(52) U.S. Cl. 281/29

(57) ABSTRACT

A file device includes one or more cover members each having one or more surfaces ground or polished into a smooth surface and formed as a white board for note making purposes. The notes may be easily removed with board erasers, toilet papers, hands of users, etc., such that no paper sheets will be wasted. One or more inner sheets may further be attached to the cover member with such as clips or binding members, and each may include one or more surfaces ground or polished into a smooth surface and formed as a white board for note making purposes.

### BACKGROUND OF THE INVENTION

1. Field of the Invention

The present invention relates to a file device, and more particularly to a file device having white board members.

2. Description of the Prior Art

Typical file devices comprise various kinds of arrangements or configurations, such as file and ring binders, organizers, notebooks, clip boards, memo pads, document cases, etc. However, the typical file devices have no informal note paper sheets for note making purposes, such that the users have to prepare and attach informal note paper sheets to the file devices. Without the informal note paper sheets, the users may have to use the formal paper sheets to make notes.

In addition, after the informal or formal paper sheets have been written or taken notes thereon, the paper sheets should be discarded and may not be used again, because the notes may not be easily removed from the informal or formal paper sheets.

Furthermore, the typical file devices normally comprise one or more cover members formed or made of paper boards, or plastic sheets, etc., and may not be taken notes thereon. When the cover members of the typical file devices are taken notes with pencils, pens, etc., it will be difficult to remove the notes from the cover members of the typical file devices.

The present invention has arisen to mitigate and/or obviate the afore-described disadvantages of the conventional or typical file devices.

### SUMMARY OF THE INVENTION

The primary objective of the present invention is to provide a file device including one or more white boards provided or attached or formed therein, for easily and readily making notes without using or wasting informal or formal paper sheets.

In accordance with one aspect of the invention, there is provided a file device comprising a cover member including at least one surface thereof polished into a smooth surface and formed as a white board for note making purposes. The notes may be easily removed with board erasers, toilet papers, hands of users, etc., such that no paper sheets will be wasted.

One or more inner sheets may further be provided and attached to the cover member, the inner sheets each may include one or more surfaces polished into a smooth surface and formed as a white board for note making purposes.

Another or a second cover member and a middle panel may further be provided and attached to the cover member with hinge lines, the inner sheets may be attached to the middle panel. A binding member may further be provided and attached to the middle panel to engage with and to secure the inner sheets to the middle panel.

The inner sheets may each include an index attached thereto. The cover member may further include a clip attached thereto for attaching or securing inner sheets or paper sheets to the cover member.

Further objectives and advantages of the present invention will become apparent from a careful reading of the detailed description provided herein below, with appropriate reference to the accompanying drawings.

### BRIEF DESCRIPTION OF THE DRAWINGS

FIG. 1 is a perspective view of a file device in accordance with the present invention, which is formed as a memo pad;

FIG. 2 is a perspective view of the file device, which is formed as a flip chart;

FIGS. 3 and 4 are perspective views of the file device, which are formed as a file and ring binder;

FIGS. 5 and 6 are perspective views of the file device, which are formed as an organizer or a notebook;

FIGS. 7 and 8 are perspective views of the file device, which are formed as a document case; and

FIG. 9 is a perspective view of the file device, which is formed as a clip board.

### DETAILED DESCRIPTION OF THE PREFERRED EMBODIMENT

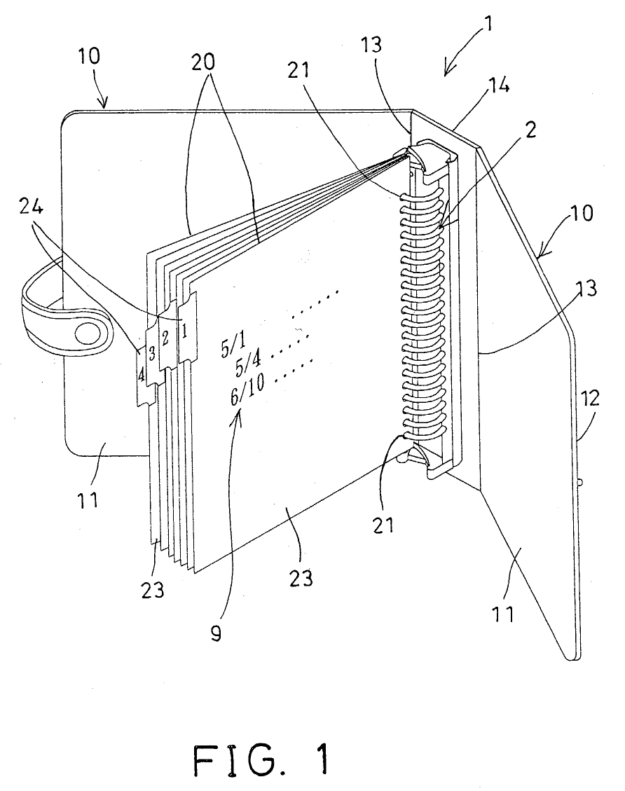

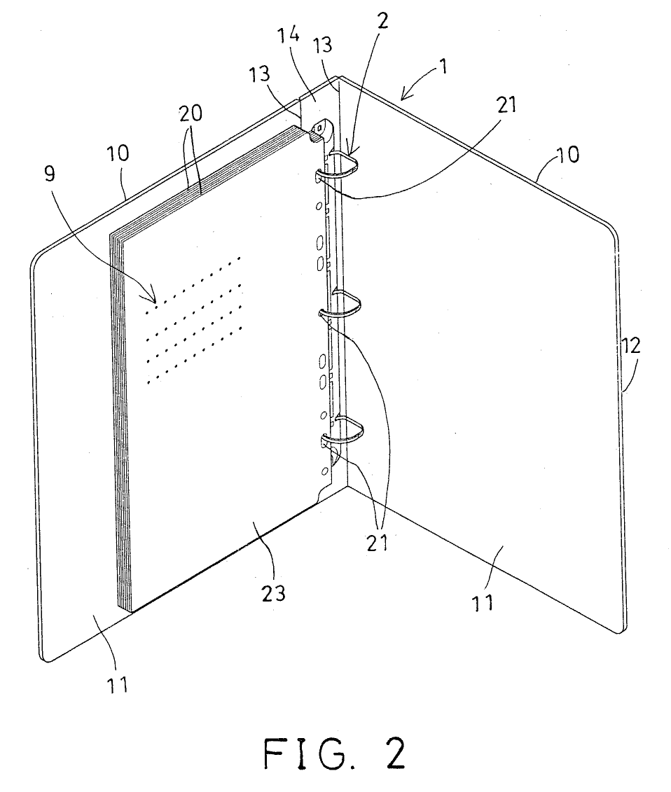

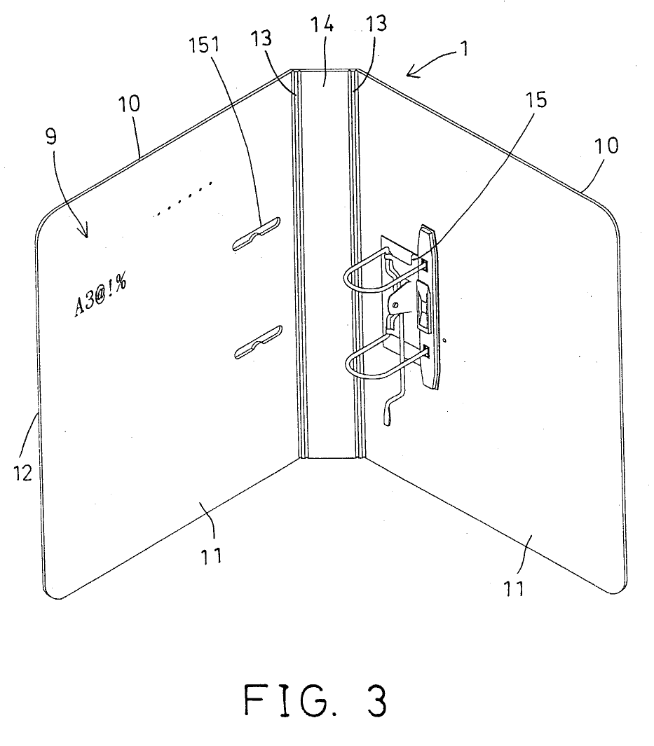

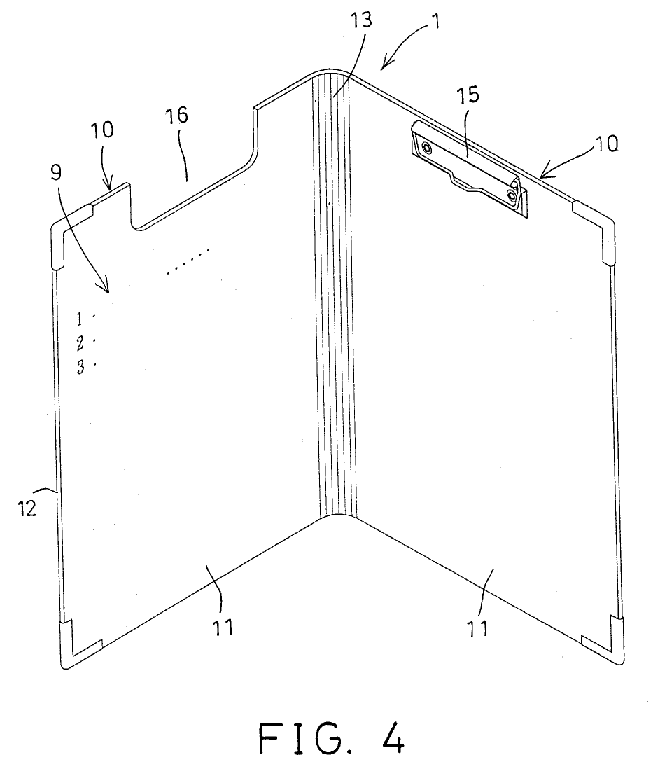

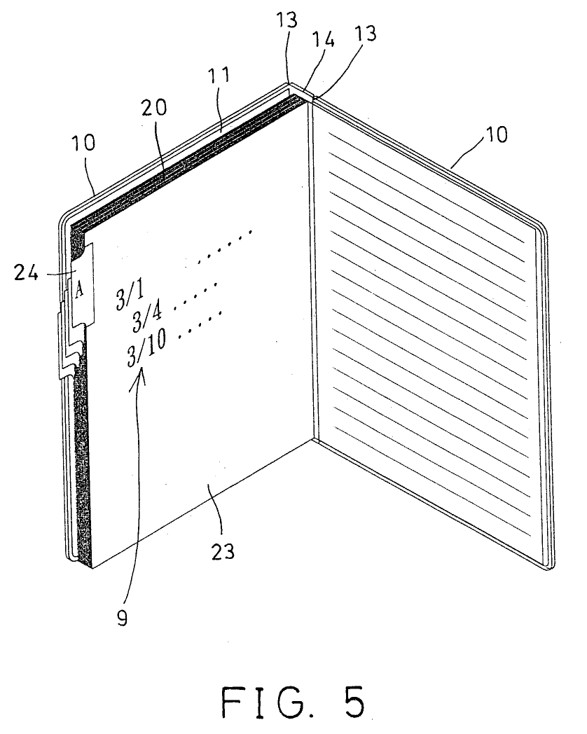

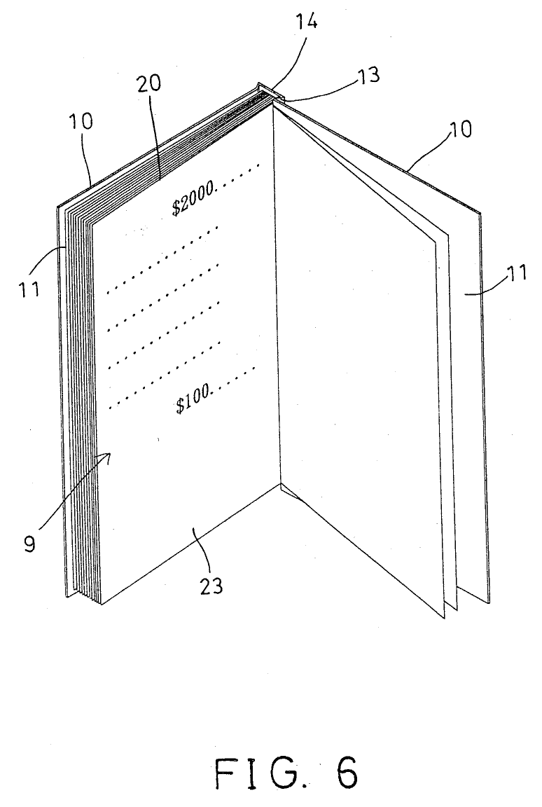

Referring to the drawings, and initially to FIGS. 1-6, a file device 1 in accordance with the present invention comprises one or more cover members 10, such as two cover members 10 foldably secured together with one or more hinge lines 13, and a middle panel 14 formed or provided between the cover members 10, and secured to the cover members 10 with hinge lines 13, for allowing the cover members 10 to be folded into such as a memo pad as shown in FIG. 1, a flip chart as shown in FIG. 2, a file and ring binder as shown in FIGS. 3 and 4, or an organizer or notebook as shown in FIGS. 5 and 6.

The cover members 10 each includes an inner planar surface 11 ground or polished into a smooth surface 11 and formed as a white board that may be made notes 9 thereon, and the notes 9 may be easily removed with board erasers, toilet papers, hands of users, etc. The cover members 10 are preferably made of plastic, acrylic, synthetic materials or the like that may be ground or polished into smooth surfaces 11 and that may be formed as a white board.

The cover members 10 each includes an outer planar surface 12 that may also be ground or polished into a smooth surface 12 and may also be formed as a white board for allowing notes 9 to be made thereon. However, the outer surface 12 of the cover member 10 is normally applied with patterns, information, advertisements, marks, etc. thereon, and is thus not suitable for being ground or polished into a smooth surface.

A binding member 2 may further be provided and attached to the middle panel 14 of the file device 1, for binding or securing or attaching inner sheets 20 to the file device 1. The inner sheets 20 each includes one or more orifices 21 formed therein for engaging with the binding member 2 which may thus be used to secure the inner sheets 20 to the file device 1.

The inner sheets 20 each includes one or two planar surfaces 23 each being ground or polished into a smooth surface 23 and formed as a white board that may be made notes 9 thereon, and the notes 9 may also be easily removed with board erasers, toilet papers, hands of users, etc. The inner sheets 20 are also preferably made of plastic, acrylic, synthetic materials or the like that may be ground or polished into smooth surfaces 23 and that may be formed as a white board.

Alternatively, as shown in FIGS. 3 and 4, the file device 10 may include one or more clips 15 attached thereto, for securing or attaching or retaining paper or inner sheets 20 therein. As shown in FIG. 3, one of the cover members 10 may include one or more openings 151 formed therein for partially receiving the clip 15 that is attached to the other cover member 10. Alternatively, as shown in FIG. 4, one of the cover members 10 may include one or more notches 16 formed therein for partially receiving the clip 15 that is attached to the other cover member 10.

As shown in FIGS. 5 and 6, the paper or inner sheets 20 may also be directly attached or secured to the middle panel 14 of the file device 1, by such as adhesive materials, to form as the organizer or the notebook. The inner sheets 20 and the cover members 10 may each be formed as a white board for easily and readily note making purposes. As shown in FIG. 1, an index 24 may be attached onto each of the inner sheets 20.

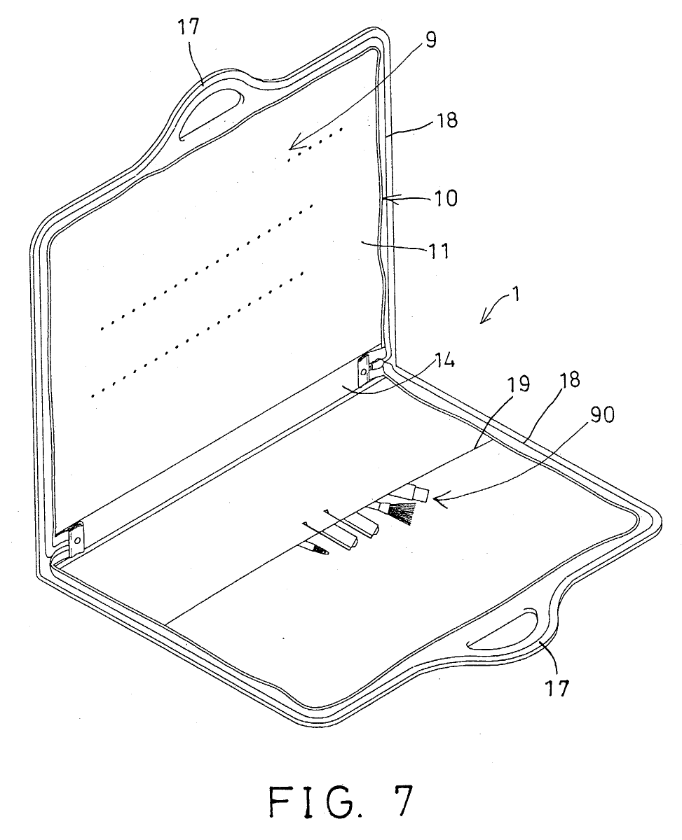

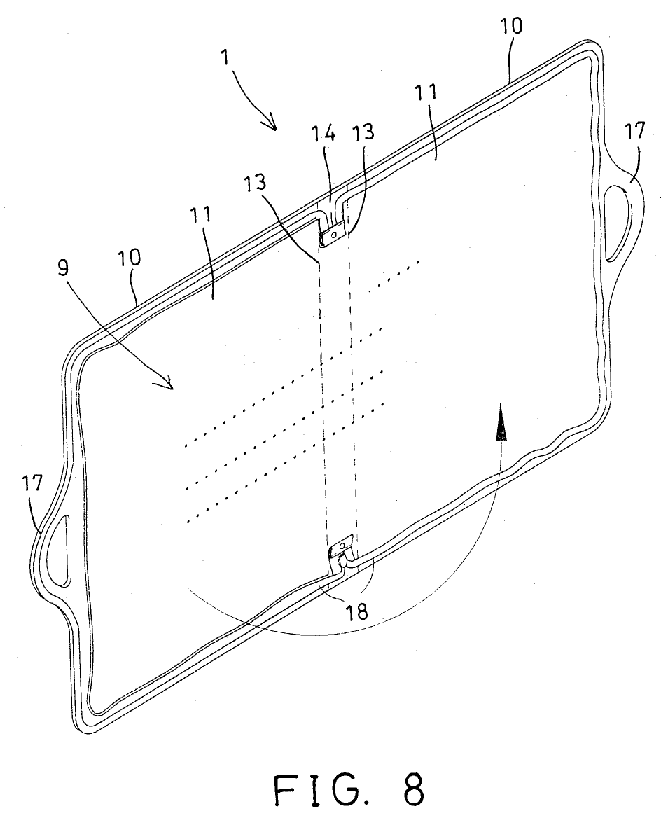

As shown in FIGS. 7 and 8, the file device 1 may further include one or more hand grips 17 provided thereon, such as attached or formed on the cover members 10, for carrying purposes, and may further include a zipper device 18 attached to the cover members 10, for openably securing the cover members 10 together. The file device 1 may further include one or more pockets 19 provided therein to receive or store various objects 90, particularly stationery goods 90 therein. The file device 1 also includes one or more surfaces 11 that may be ground or polished into a smooth surface 11 and formed as a white board for note making purposes.

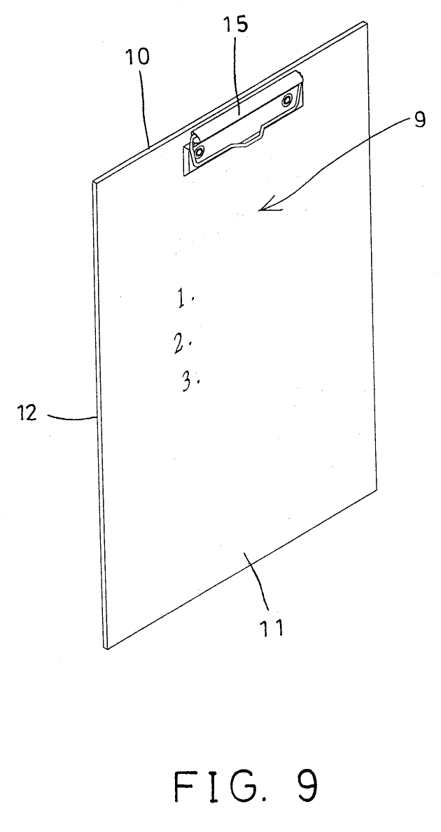

As shown in FIG. 9, the file device may also include a single cover member 10 having a clip 15 attached thereon, for forming as a clip board, and having one or more surfaces 11 that may also be ground or polished into a smooth surface 11 and formed as a white board that may be made notes 9 thereon.

Accordingly, the file device in accordance with the present invention includes one or more white boards provided or attached or formed therein, for easily and readily making notes without using or wasting informal or formal paper sheets.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A file device comprising:
a cover member including at least one surface thereof polished into a smooth surface and formed as a white board for note making purposes.

2. The file device as claimed in claim 1 further comprising at least one inner sheet attached to said cover member, said at least one inner sheet including at least one surface thereof polished into a smooth surface and formed as a white board for note making purposes.

3. The file device as claimed in claim 2 further comprising a second cover member and a middle panel attached to said cover member with hinge lines, said at least one inner sheet being attached to said middle panel.

4. The file device as claimed in claim 3 further comprising a binding member attached to said middle panel to engage with and to secure said at least one inner sheet to said middle panel.

5. The file device as claimed in claim 2, wherein said at least one inner sheet includes an index attached thereto.

6. The file device as claimed in claim 1, wherein said cover member includes a clip attached thereto.
